(19) United States
(12) Patent Application Publication
(10) Pub. No.: US 2016/0196209 A1
(43) Pub. Date: Jul. 7, 2016

(54) MEMORY CONTROLLER, METHOD OF CONTROLLING THE SAME, AND SEMICONDUCTOR MEMORY DEVICE HAVING BOTH

(71) Applicant: SK hynix Inc., Gyeonggi-do (KR)

(72) Inventor: Jungug KIM, Seoul (KR)

(21) Appl. No.: 14/591,710

(22) Filed: Jan. 7, 2015

(51) Int. Cl. G06F 12/08

(52) U.S. Cl. CPC G06F 12/0802; G06F 2212/1024

(57) ABSTRACT

A memory controller, a method of controlling the same, and a semiconductor memory device having the same are provided. The memory controller includes a cache memory provided between an external host and a nonvolatile memory; and a memory manager suitable for storing a plurality of determination values respectively corresponding to a plurality of addresses of the cache memory, wherein the memory manager selects one of the plurality of addresses as a load address corresponding to data to be loaded in the cache memory based on the plurality of the determination values, and initialize the determination value corresponding to the load address based on a type of a command from the host.

### BACKGROUND

1. Field of Invention

The present invention relates to an electronic device, More specifically, the present invention relates to a memory controller, a method of controlling the same, and a semiconductor memory device incorporating both.

2. Description of Related Art

Instead of conventional hard disk drives (HDD), which rotate a physical disk and are slow, heavy, large, and noisy, the use of semiconductor memory devices is increasing.

Semiconductor memory devices include nonvolatile memory for storing data and cache memory, which has a faster access time than nonvolatile memory. Cache memory stores frequently used data. When the stored data includes data required from an external device, the data is read from the cache memory and supplied to the external device.

The cache memory has a relatively small capacity due to cost and other reasons, so it is always important to use this space efficiently and find methods for reducing access time to the cache memory. For example, only frequently accessed data is managed in the cache memory.

### SUMMARY

The present invention is directed to a memory controller having an improved access speed, a method of controlling the same, and a semiconductor memory device incorporating both.

One aspect of the present invention provides a memory controller including: a cache memory provided between an external host and a nonvolatile memory; and a memory manager suitable for storing a plurality of determination values respectively corresponding to a plurality of addresses of the cache memory, wherein the memory manager selects one of the plurality of addresses as a load address corresponding to data to be loaded in the cache memory based on the plurality of the determination values, and initialize the determination value corresponding to the load address based on a type of a command from the host.

Another aspect of the present invention provides a method of controlling a memory controller including a plurality of determination values respectively corresponding to a plurality of addresses of a cache memory provided between an external host and a nonvolatile memory, including: receiving a command from the host, and updating the plurality of the determination values; selecting one of the plurality of addresses as a load address corresponding to data to be loaded in the cache memory based on the plurality of the updated determination values; and initializing the determination value corresponding to the load address based on a type of the command.

Another aspect of the present invention provides semiconductor memory device including: a nonvolatile memory suitable for storing data; and a memory controller including: a cache memory provided between the nonvolatile memory and an external host; and a memory manager suitable for storing a plurality of determination values respectively corresponding to a plurality of addresses of the cache memory, wherein the memory manager selects one of the plurality of addresses as a load address corresponding to data to be loaded in the cache memory based on the plurality of the determination values, and initialize the determination value corresponding to the load address based on a type of a command from the host.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1A is a block diagram illustrating a semiconductor memory device according to an exemplary embodiment of the present invention;

FIG. 1B is a table illustrating address data stored in a memory controller according to the exemplary embodiment of the present invention.

FIG. 2 is a flowchart illustrating a method of controlling the memory controller according to the exemplary embodiment of the present invention;

FIG. 3 is a flowchart illustrating step S1000 shown in FIG. 2; and

FIG. 4 is a flowchart illustrating step S1300 shown in FIG. 3.

### DETAILED DESCRIPTION

The present invention will be described more fully hereinafter with reference to the accompanying drawings in which exemplary embodiments of the invention are shown. This invention may, however, be embodied in different forms and should not be construed as limited to the embodiments set forth herein.

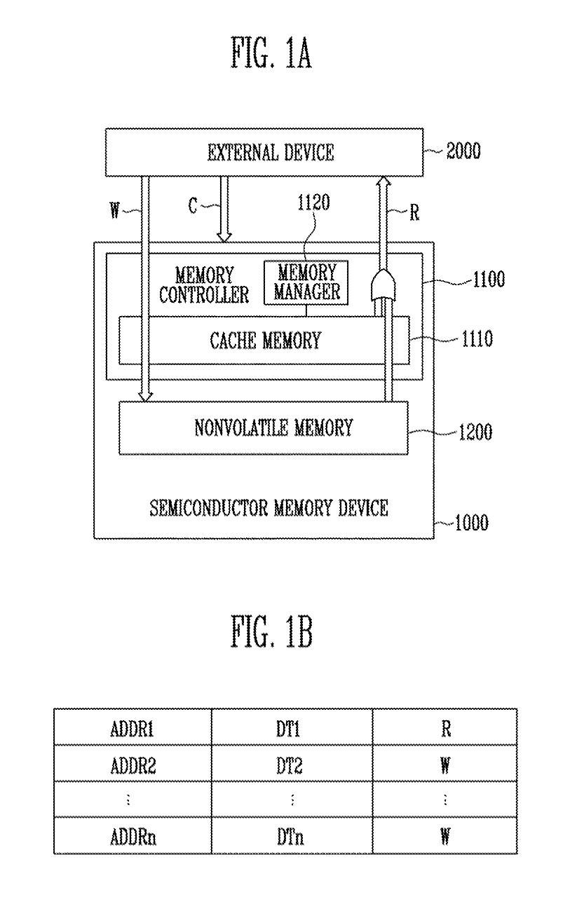

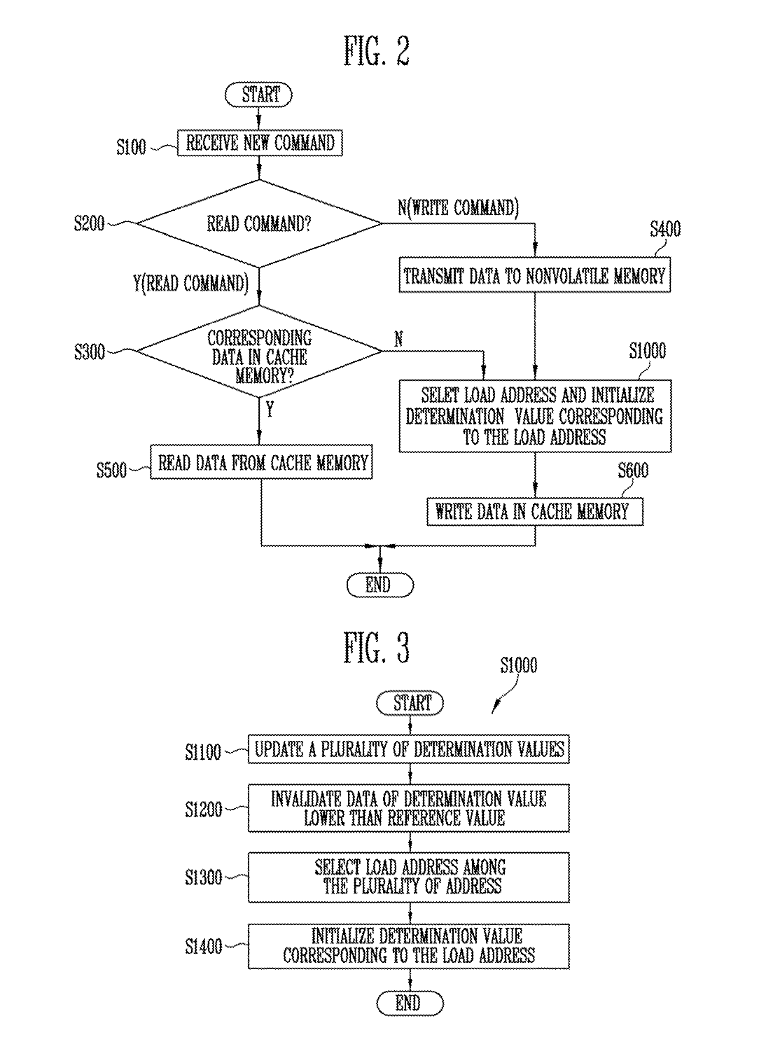

FIG. 1A is a block diagram illustrating a semiconductor memory device according to an exemplary embodiment of the present invention, and FIG. 1B is a table illustrating address data stored in a memory controller according to the exemplary embodiment of the present invention.

Referring to FIG. 1A, the semiconductor memory device 1000 may include a memory controller 1100 and a nonvolatile memory 1200, and may receive a command C from the external device (a host application and/or the like) 2000. The command C may be one of a read command, a write command, and/or the like. The memory controller 1100 may include a cache memory 1110 and a memory manager 1120. The cache memory 1110 may include a plurality of storage areas corresponding to a plurality of addresses. The memory manager 1120 may manage data loaded in the cache memory 1110 based on a plurality of determination values respectively corresponding to the plurality of addresses of the cache memory 1110.

The determination value may represent the number of accesses of an address of the cache memory 1110, and may be a criterion for invalidation of data loaded in the cache memory 1110. The determination values corresponding to the plurality of addresses may be initialized to different values according to the type of command corresponding to the plurality of addresses.

Referring to FIG. 16, the memory manager 1120 of the memory controller 1100 may manage a table including information of the determination values and the types of the commands, each of which corresponds to the plurality of the addresses, respectively. FIG. 1B exemplarily shows the table including the information of the plurality of addresses ADDR1 to ADDRn in a first column, the determination values DT1 to DTn respectively corresponding to the addresses ADDR1 to ADDRn in a second column, and the type of command C for loading data corresponding to the addresses ADDR1 to ADDRn in the third column. In the third column, ‘R’ represents the read command, and ‘W’ represents the write command.

Hereinafter a storage area in which data for the read command R is loaded is referred to as a read-load storage area, and a storage area in which data for the write command is loaded is referred to as a write-load storage area. Also, an address corresponding to the read-load storage area is referred to as a read-load address, and an address corresponding to the write-load storage area is referred to as a write-load address. In addition, loaded data for the read command R is referred to as read-load data, and loaded data for the write command is referred to as write-load data.

Referring back to FIG. 1A, when the read command R is received from the external device 2000, the memory controller 1100 may perform the read operation. The memory controller 1100 may determine whether data for the read command R is stored in the cache memory 1110. When the data for the read command R is loaded in the cache memory 1110, the data for the read command R is transmitted from the cache memory 1110 to the external device 2000 without the access to the nonvolatile memory 1200. When the data for the read command R is not loaded in the cache memory 1110, the data for the read command R may be read from the nonvolatile memory 1200 and may be transmitted to the external device 2000. Also, the data for the read command R may be loaded in the cache memory 1110.

When the write command is received from the external device 2000, the memory controller 1100 may perform the write operation. Data received with the write command may be stored in the nonvolatile memory 1200 and loaded in the cache memory 1110.

When the data for the read or write command C is loaded in the cache memory 1110, the memory manager 1120 may select a load address among the plurality of addresses corresponding to a storage area in the cache memory 1110 for loading the data for the command C, and initialize the determination value corresponding to the selected load address. As described above, the determination values corresponding to the load address may be initialized to be different values according to the type of the command C corresponding to the load address.

A read time of the nonvolatile memory 1200 may be longer than a write time of the nonvolatile memory 1200. Also, the read-load data may have a high probability of being read again by the read command R. In this case, the access time of the nonvolatile memory 1200 may be reduced by loading the read-load data in the cache memory 1110 at a higher rate than that of the write-load data. For the loading of the read-load data in the cache memory 1110 at a higher rate than that of the write-load data, an initial value (hereinafter, referred to as a read-load initial value) of a determination value corresponding to the read-load storage area may be set higher than an initial value (hereinafter, referred to as a write-load initial value) of a determination value corresponding to the write-load storage area. Then, the determination values stored in the table of the memory manager 1120 may be decreased whenever receiving the corresponding command C. That is, when the storage area in the cache memory 1110 needs to be secured and thus a part of the data loaded in the cache memory 1110 needs to be invalidated, the memory manager 1120 may invalidate the loaded data in the cache memory 1110 currently having the smallest determination value. Thus, for example, when the initial read-load value is set to be higher than the initial write-load value, the invalidation probability of the read-load data may be lower than the invalidation probability of the write-load data.

It is exemplarily described above that the initial read-load value is set to be higher than the initial write-load value, the determination values stored in the table of the memory manager 1120 decreases whenever receiving the corresponding command C, and the memory manager 1120 invalidates the loaded data in the cache memory 1110 currently having the smallest determination value so that the invalidation probability of the read-load data is lower than the invalidation probability of the write-load data. However, it is also possible that the initial read-load value may be set to be lower than the initial write-load value, the determination values stored in the table of the memory manager 1120 may be increased whenever receiving the corresponding command C, and the memory manager 1120 may invalidate the loaded data in the cache memory 1110 currently having the greatest determination value so that the invalidation probability of the read-load data is lower than the invalidation probability of the write-load data.

The memory manager 1120 may select the load address among the plurality of addresses. The memory manager 1120 may select an empty address, which corresponds to the storage area of the cache memory 1110 having no load data, as the load address corresponding to data to be loaded in the storage area. Also, the memory manager 1120 may select one of the existing load addresses, which corresponds to the storage area of the cache memory 1110 currently having the loaded data, as the load address corresponding to the data to be loaded in the storage area with invalidation of the currently loaded data in the storage area. The currently loaded data that was in the storage area may be deleted or overwritten.

For the invalidation, the memory manager 1120 may choose the load address having the smallest determination value. When the number of load addresses having the smallest determination value is two or more, the memory manager 1120 may use additional criteria (the type of the command C, a recently updated time, and/or the like) to select one among the two or more load address having the smallest determination value.

For example, when the number of existing load addresses having the smallest determination value is two or more, the memory manager 1120 may choose the existing load address that corresponds to the write command, among the two or more load addresses having the smallest determination value, by referring to the type of the command in the table. As described above, the loading of the read-load data in the cache memory 1110 reduces the access time to the nonvolatile memory 1200 greater than the loading of the write-load data in the cache memory 1110, and thus invalidation of the write-load data is more effective than invalidation of the read-load data for reducing access time to the nonvolatile memory 1110.

For another example, when the number of existing load addresses having the smallest determination value is two or more, the memory manager 1120 may choose the existing load address that was loaded first. More recently loaded data may have higher probability of being accessed again than previously loaded data in the cache memory 1110, and thus invalidation of the previously loaded data is more effective than invalidation of more recently loaded data for reducing access time to the nonvolatile memory 1110.

FIG. 2 is a flowchart illustrating a method of controlling the memory controller according to an exemplary embodiment of the present invention. Hereinafter, the descriptions will be referenced with FIGS. 1A, 1B, and 2.

At step S100, the memory controller 1100 may receive a new command C from the external device 2000.

At step S200, the memory controller 1100 may determine whether the command C received from the external device 2000 is the read command or the write command. When the command received from the external device 2000 is the read command, the operation S300 is performed. When the command received from the external device 2000 is the write command, operation S400 is performed.

At step S300, the memory controller 1100 may check whether the data corresponding to the read command is already in the cache memory 1110. When the load data corresponding to the read command is in the cache memory 1110, the operation S500 is performed. When the load data corresponding to the read command is not in the cache memory, the operation S1000 is performed.

At step S400, the memory controller 1100 may transmit data received with the write command to the nonvolatile memory 1200. The received data may be loaded in the cache memory 1110 through steps S1000 and S600.

At step S500, when the load data corresponding to the read command is in the cache memory 1110, the memory controller 1100 may read and transmit the load data corresponding to the read command in the cache memory 1110 to the external device 2000.

When data is to be newly loaded in the cache memory 1110 according to the read or write commands, that is, when the data corresponding to the read command is not currently loaded in the cache memory 1110 and is to be loaded from the nonvolatile memory 1110 according to step S300, or when the data corresponding to the write command is to be loaded in the cache memory 1110, at step S1000, the memory controller 1100 may choose an empty address or one of the existing load addresses, which correspond to the storage area of the cache memory 1110 currently having the loaded data, as the load address corresponding to the data to be newly loaded in the storage area with invalidation of the currently loaded data in the storage area. Step S1000 will be explained later in detail.

At step S600, the memory controller 1100 loads data in a storage area corresponding to the load address among the cache memory 1110. When the command C is a read command, the data read from the nonvolatile memory 1200 is loaded. When the command C is a write command, the data received with the write command is loaded.

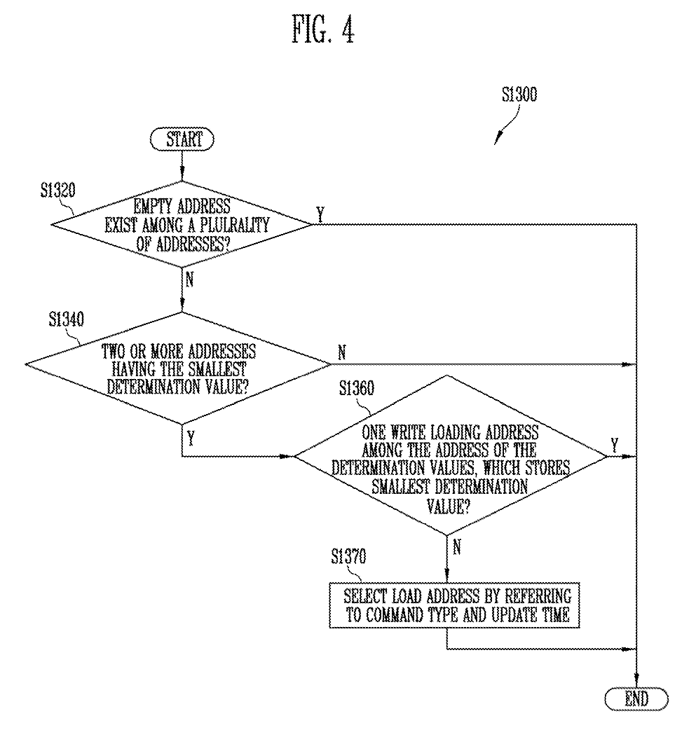

FIG. 3 is a flowchart illustrating step S1000 shown in FIG. 2.

At step S1100, the memory manager 1120 may update the plurality of determination values according to the received command at step S100. The determination values stored in the table of the memory manager 1120 may be decreased.

At step S1200, the memory manager 1120 may invalidate the loaded data in the cache memory 1110 corresponding to a determination value that is currently smaller than a reference value. The load data may be directly erased or overwritten. Step S1200 may be optional. The above-deserted step S1200 may be applied to the case in which the determination values decrease whenever receiving the command C. On the other hand, in the case where the determination values increase whenever receiving the command C, the memory manager 1120 may invalidate the loaded data in the cache memory 1110 currently having a determination value greater than a reference value at step 1200.

At step S1300, the memory manager 1120 may choose an empty address or one of the existing load addresses, which corresponds to the storage area of the cache memory 1110 currently having the loaded data, as the load address corresponding to the data to be newly loaded in the storage area. Details of operation S1300 will be explained with reference to FIG. 4.

At step S1400, the memory manager 1120 may invalidate the currently loaded data, load the data corresponding to the selected load address in the storage area, and initialize the determination value corresponding to the selected load address. The memory controller 1100 may determine the type of command received from the external device 2000 at step S100. When the command C is the read command, the memory manager 1120 may initialize the determination value corresponding to the selected address to the read-load initial value. That is, the read-load initial value corresponding to the selected address may be stored in the second column of the stored table. When the command C is the write command, the memory manager 1120 may initialize the determination value corresponding to the selected address to the write-load initial value. That is, the write-load initial value corresponding to the selected address may be stored in the second column of the stored table. Also, the memory manager 1120 may update the type of command in the third column of the stored table.

FIG. 4 is a flowchart illustrating step S1300 shown in FIG. 3.

At step S1320, the memory manager 1120 may determine whether an empty address exists, which corresponds to the storage area of the cache memory 1110 having no load data. Step S1200 may be performed after step S1320 in order to secure the empty address or the storage area of the cache memory 1110 having no load data when there is no empty address or no storage area of the cache memory 1110 having no load data.

At step S1320, when the empty address exists, the memory manager 1120 may select the empty address as the load address corresponding to data to be loaded in the storage area, and then proceed to step S1400.

When the empty address does not exist, the memory manager 1120 may select one of the existing load addresses that corresponds to the storage area of the cache memory 1110 currently having loaded data as the load address corresponding to the data to be loaded in the storage area by using the various criteria through the following steps S1340 to S1370.

At step S1340, when the number of existing load addresses having the smallest determination value is one, the memory manager 1120 may choose the single existing load address having the smallest determination value as the load address corresponding to data to be loaded in the storage area, and then proceed to step S1400. The above-described step S1340 may be applied to the case in which the determination values decrease whenever receiving the command C. On the other hand, in the case where the determination values increase whenever receiving the command C, the memory manager 1120 may choose a single address with the greatest determination value as the load address.

At step S1360, when the number of existing load addresses having the smallest determination value is two or more, and when the number of the write-load addresses among the existing load addresses having the smallest determination value is one, the memory manager 1120 may choose a single write-load address having the smallest determination value as the load address corresponding to data to be loaded in the storage area, and then proceed to step S1400. As described above, loading of the read-load data in the cache memory 1110 reduces access time more than loading of the write-load data in the cache memory 1110, and thus invalidation of the write-load data s more effective than invalidation of the read-load data for reducing access time to the nonvolatile memory 1110.

When all of the existing load addresses having the smallest determination values are the read-load addresses, or the number of existing write-load addresses among the existing load addresses having the smallest determination value is two or more, at step S1370 the memory manager 1120 may choose the existing load address that was loaded first-in-time. As described above, more recently loaded data may have a higher probability of being accessed again than previously loaded data in the cache memory 1110, and thus invalidation of the previously loaded data is more effective than invalidation of more recently loaded data for reducing access time to the nonvolatile memory 1110. For example, when the number of existing write-load addresses among the existing load addresses having the smallest determination value is two more, the memory manager 1120 may choose one of the two or more existing write-load addresses that has the smallest determination value and is loaded first-in-time as the load address corresponding to data to be loaded in the storage area, and then proceed to step S1400. For another example, when all of the existing load addresses having the smallest determination value are read-load addresses, the memory manager 1120 may choose one of the read-load addresses that has the smallest determination value and is loaded first-in-time as the load address corresponding to data to be loaded in the storage area, and then proceed to step S1400.

The process order of steps S1340 to S1370 described above may vary according to design.

According to the exemplary embodiments of the present invention, a memory controller having improved access speed, the method of controlling the memory controller are provided.

Now that the present invention has been explained with reference to the exemplary embodiments, it will be apparent to those skilled in the art that various modifications can be made to the above-described exemplary embodiments of the present invention without departing from the spirit or scope of the invention.

The technical scope of the present invention is disclosed in the appended claims, and it is intended that the present invention cover all modifications provided they come within the scope of the claims and their equivalents.

What is claimed is:

1. A memory controller comprising:
a cache memory provided between an external host and nonvolatile memory; and
a memory manager suitable for storing a plurality of determination values respectively corresponding to a plurality of addresses of the cache memory,
wherein the memory manager selects one of the plurality of addresses as a load address corresponding to data to be loaded in the cache memory based on the plurality of the determination values, and initializes the determination value corresponding to the load address based on a type of a command from the host.

2. The memory controller of claim 1, wherein the data to be loaded is received from the host or the nonvolatile memory.

3. The memory controller of claim 2,
wherein the memory manager decreases the plurality of the determination values whenever receiving the command, and
wherein the memory manager invalidates currently loaded data, which corresponds to one of the plurality of determination values smaller than a reference value, in the cache memory.

4. The memory controller of claim 1, wherein the memory manager selects an empty address corresponding to a storage area of the cache memory having no load data as the load address before selecting one of the plurality of addresses as the load address based on the plurality of the determination values.

5. The memory controller of claim 4, wherein the memory manager selects one of two or more addresses having the smallest determination value among the plurality of addresses that corresponds to a predetermined type of the command based on the type of the command.

6. The memory controller of claim 4, wherein the memory manager selects one of two or more addresses having the smallest determination value among the plurality of addresses that corresponds to data loaded first-in-time in the cache memory.

7. The memory controller of claim 5, wherein the memory manager selects one of two or more addresses corresponding to the predetermined type of the command, which corresponds to data loaded first-in-time in the cache memory.

8. A method of controlling a memory controller including a plurality of determination values respectively corresponding to a plurality of addresses of a cache memory provided between an external host and a nonvolatile memory, comprising:
receiving a command from the host, and updating the plurality of determination values;
selecting one of the plurality of addresses as a load address corresponding to data to be loaded in the cache memory based on the plurality of the updated determination values; and
initializing the determination value corresponding to the load address based on a type of the command.

9. The method of claim 8, further comprising invalidating currently loaded data in the cache memory that corresponds to a predetermined one of the plurality of the updated determination values.

10. The method of claim 9,
wherein the updating of the plurality of the determination values decreases the plurality of the determination values, and
wherein the predetermined one of the plurality of updated determination values is smaller than a reference value.

11. The method of claim 8, further comprising selecting an empty address corresponding to a storage area of the cache memory having no load data as the load address before the selecting of one of the plurality of addresses.

12. The method of claim 8, wherein the selecting of one of the plurality of addresses selects one among the plurality of addresses that has the smallest determination value.

13. The method of claim 11, wherein the selecting of one of the plurality of addresses selects one of two or more addresses having the smallest determination value among the plurality of addresses, which corresponds to a predetermined type of the command, based on the type of the command.

14. The method of claim 11, wherein the selecting of one of the plurality of addresses selects one of two or more addresses having the smallest determination value among the plurality of addresses that corresponds to data loaded first-in-time in the cache memory.

15. A semiconductor memory device comprising:
a nonvolatile memory suitable for storing data; and
a memory controller including:
a cache memory provided between the nonvolatile memory and an external host; and
a memory manager suitable for storing a plurality of determination values respectively corresponding to a plurality of addresses of the cache memory,
wherein the memory manager selects one of the plurality of addresses as a load address corresponding to data to be loaded in the cache memory based on the plurality of the determination values, and initializes the determination value corresponding to the load address based on a type of a command from the host.

16. The semiconductor memory device of claim 15,
wherein the memory manager decreases the plurality of the determination values whenever receiving the command, and
wherein the memory manager invalidates currently loaded data in the cache memory that corresponds to one of the plurality of determination values smaller than a reference value.

17. The semiconductor memory device of claim 15, wherein the memory manager selects an empty address corresponding to a storage area of the cache memory having no load data as the load address before selecting one of the plurality of addresses as the load address based on the plurality of the determination values.

18. The semiconductor memory device of claim 17, wherein the memory manager selects one of two or more addresses having the smallest determination value among the plurality of addresses, which corresponds to a predetermined type of the command, based on the type of the command.

19. The semiconductor memory device of claim 7, wherein the memory manager selects one of two or more addresses having the smallest determination value among the plurality of addresses, which corresponds to data loaded first-in-time in the cache memory.

20. The semiconductor memory device of claim 18, wherein the memory manager selects one of two or more addresses corresponding to the predetermined type of the command, which corresponds to data loaded first-in-time in the cache memory.
